(19) United States
(12) Patent Application Publication
(10) Pub. No.: US 2024/0111820 A1
(43) Pub. Date: Apr. 4, 2024

(54) DIGITAL CONTENT CAPTURE RECOMMENDATIONS

(71) Applicant: Motorola Mobility LLC, Chicago, IL (US)

(72) Inventors: Amit Kumar Agrawal, Bangalore (IN); Rahul Bharat Desai, Hoffman Estates, IL (US); Srikanth Raju, Sahakaranagar (IN); Renuka Prasad Herur Rajashekaraiah, Bangalore (IN)

(73) Assignee: Motorola Mobility LLC, Chicago, IL (US)

(21) Appl. No.: 17/957,455

(22) Filed: Sep. 30, 2022

(51) Int. Cl. G06F 16/9535; G06F 16/2457

(52) U.S. Cl. CPC G06F 16/9535; G06F 16/2457

(57) ABSTRACT

Techniques for digital content capture recommendations are described and are implementable to generate a recommendation for a digital content capture at a particular location based on capture data stored in a database. The described implementations enable generation of a recommendation including a suggested location, time of day, date, and/or various device configuration settings to capture an instance of digital content such as a photograph. For instance, a request for a recommendation for a digital content capture at a particular location is received. A database including capture data associated with digital content captured at the particular location is accessed, and the recommendation is generated based on the capture data. The recommendation is then displayed in a user interface of a client device.

### BACKGROUND

Today's modern devices provide users with a variety of different opportunities for capturing multimedia content. For instance, a typical smart device (e.g., a smartphone) includes image capture capability for capturing still images and video, with an extensive selection of camera features and settings. Many modern smartphone cameras are capable of capturing content with similar quality to professional cameras and accordingly smartphone photography is more accessible than ever. However, current ways for guiding content capture are limited which can reduce user satisfaction and offset the benefits associated with smartphone photography.

### BRIEF DESCRIPTION OF THE DRAWINGS

Aspects of digital content capture recommendations are described with reference to the following Figures. The same numbers may be used throughout to reference similar features and components that are shown in the Figures:

FIG. 1 illustrates an example environment in which aspects of digital content capture recommendations can be implemented.

FIG. 2 depicts an example system for digital content capture recommendations in accordance with one or more implementations.

FIG. 3 depicts an example implementation for digital content capture recommendations in which the recommendation is based in part on user specified preferences in accordance with one or more implementations.

FIG. 4 depicts an example implementation for digital content capture recommendations in which the recommendation is based in part on demographic data in accordance with one or more implementations.

FIG. 5 depicts an example implementation for digital content capture recommendations in which the recommendation is further based in part on demographic data in accordance with one or more implementations.

FIG. 6 depicts an example implementation for digital content capture recommendations in which the recommendation includes a popular digital content capture suggestion in accordance with one or more implementations.

FIG. 7 depicts an example implementation for digital content capture recommendations in which the recommendation includes an exclusive content capture suggestion in accordance with one or more implementations.

FIG. 8 depicts an example implementation for digital content capture recommendations in which a recommendation score is generated for an instance of digital content in accordance with one or more implementations.

FIG. 9 illustrates a flow chart depicting an example method for digital content capture recommendations in accordance with one or more implementations.

FIG. 10 illustrates a flow chart depicting an example method for digital content capture recommendations including generating a recommendation score in accordance with one or more implementations.

FIG. 11 illustrates various components of an example device in which aspects of digital content capture recommendations can be implemented.

### DETAILED DESCRIPTION

Techniques for digital content capture recommendations are described and are implementable to generate a recommendation for a digital content capture at a particular location based on capture data stored in a database. The described implementations, for instance, enable generation of a recommendation to capture digital content including a suggested location, time of day, date, and/or various device configuration settings based on aggregated capture data.

According to various implementations, a client device e.g., a smartphone, is operable to receive an input including a request for a recommendation for a digital content capture at a particular location. In various examples, the input is based on a user query, e.g., a request by the user in a user interface for a recommendation. The user query can further include additional criteria such as preferences that are usable in generating the recommendation. In an example, a user of the client device specifies preferences including one or more of a search radius including the particular location, a time range, a date range, preferred capture types/styles, capture themes, etc. In additional or alternative examples, the request is generated automatically and without user intervention, e.g., responsive to a detection that the client device is located at the particular location. In another example, the request is based on an itinerary as generated by the client device, e.g., where the itinerary identifies one or more destinations, and the particular location is one of the destinations.

The client device includes a content control module configured to access a database including capture data associated with various digital content. The digital content includes digital photos and videos captured at the particular location, for instance by a plurality of client devices at various times. The capture data includes information about the digital content capture such as a geolocation, time of day, date of capture, weather conditions at the time of capture, etc. In various examples, the capture data includes information about devices used to capture the digital content, including but not limited to whether a front or a rear camera of the device captured the content, a device orientation, aperture size, shutter speed, ISO setting, brightness settings, flash setting, night mode, exposure setting, image filter, contrast setting, etc. The capture data can further include demographic information for one or more users associated with capture devices that captured the digital content such as age, gender, nationality, etc. Additionally or alternatively, the capture data includes information about the digital content such as the type of digital content (e.g., a panoramic photo, “selfie” photo, live photo, video, etc.), a number of individuals depicted in the digital content, a recommendation score, social media statistics such as a number of likes and/or shares of the photo on social media, etc.

Based on the capture data, the content control module is operable to generate a recommendation for a digital content capture, e.g., instructing a user of the mobile device “where,” “when,” and “how” to capture an instance of digital content. For instance, the recommendation indicates a particular location, a time of day, a time of year, and/or suggested device configuration settings to capture digital content. In one or more examples, the configuration settings include whether to use a front camera or a rear camera, whether to capture digital content in a landscape or portrait orientation, and/or whether/how to apply visual effects such as an aperture size, shutter speed, ISO, brightness settings, flash setting, night mode, exposure setting, image filter, contrast setting, etc.

Generally, the recommendation represents a “desirable” content capture. In an example, the recommendation is based on locations, times, and configuration settings that are “popular” as indicated by the capture data. For instance, the recommendation can be based on a number of instances of digital content captured (e.g., a number of photos taken) at the particular location, captured at a particular time, and/or captured with particular configuration settings thus indicating that the particular location/time/settings are popular for capturing digital content. By way of example, consider that a user of the multicamera mobile device is visiting the Taj Mahal in Agra, India, and has requested a recommendation for a digital content capture. In this example, the capture data indicates that a popular spot to capture a photograph is directly south of the mausoleum in front of the reflecting pool, e.g., based on a number of photos included in the capture data taken from that spot. Further, a popular time is between 11:00 AM-1:00 PM, and a popular device configuration is to use the rear camera in a portrait mode with a low ISO setting, e.g., to reduce light sensitivity. Accordingly, the content control module is operable to generate a recommendation conveying this information to the user.

In various examples, a desirable content capture does not correspond to a digital content capture that is “popular.” Accordingly, a number of techniques are further considered to determine desirable content captures based on the capture data. For instance, recommendations can be based on social media statistics (e.g., a number of “likes” and/or “shares”) associated with the capture data, AI-based content scoring algorithms, machine learning based image popularity assessments, recommendation scores associated with instances of digital content in the database, etc. Consider an example in which a user desires an exclusive content capture and wishes to avoid crowded areas. Thus, a “popular” capture, e.g., based solely on a number of instances of digital content captured at a particular location, would not be a desirable content capture for this particular user.

Accordingly, the content control module is operable to generate a recommendation that adheres to such user preferences. For instance, the content control module can generate a recommendation that indicates a time to visit the particular location that isn't frequented by others and suggests a photo location and configuration settings that are “exclusive,” e.g., have few or no comparable instances of digital content represented by the capture data. The recommendation is further based on social media statistics included in the capture data that indicate a desirable capture. In the context of the above example, in which a user of the multicamera mobile device is visiting the Taj Mahal, the recommendation may suggest a content capture from the north bank of the River Yamuna facing the Taj Mahal at sunrise using a slow shutter speed, which provides a desirable content capture while avoiding crowded areas.

In one or more examples, the recommendation is based in part on demographic information associated with a user of the client device. For instance, the content control module is operable to filter the capture data based on one or more relevant demographic characteristics. Further, the content control module can leverage a machine learning collaborative filtering algorithm to generate the recommendation. For instance, the machine learning collaborative filtering algorithm is implemented by the content control module to consider one or more of the capture data, specified preferences, and/or user demographics to generate the recommendation. In this way, the content control module can generate recommendations that are tailored for individual users.

Once generated, the content control module is employed to output the recommendation for display in a user interface of the client device. As noted above, the recommendation is configured to indicate one or more of a suggested location, time of day, date, and/or configuration settings to optimize a content capture for a particular user. The recommendation can also be configured to include pose suggestions as well as instructions for capturing digital content. Pose suggestions, for instance, can include an orientation of the user, facial expressions, posture, stance, bodily movements, etc. In one or more examples, the recommendation further includes digital content examples, e.g., one or more photos or videos with similar properties to the recommendation. Thus, the content control module can provide a user with a visual representation of what content captured based on the recommendation may look like.

In some implementations, the content control module is operable to automatically configure the client device with configuration settings, e.g., based on one or more configuration settings included in the recommendation. In an example, this is responsive to a determination that the client device is located at the particular location. For instance, based on the capture data (e.g., time, location, weather conditions, etc.) the content control module is operable to configure the client device to capture an instance of digital content automatically and without user intervention. Thus, the techniques described herein facilitate user efficiency by automatically configuring the client device with optimal settings for a digital content capture in a particular context.

Further, the content control module is configured to capture an instance of digital content, e.g., with a front or rear camera of the client device. The content control module is operable to generate a recommendation score for the instance of digital content. Generally, the recommendation score represents a “value” of the instance of digital content in generating a recommendation, e.g., how the instance of digital content compares to other digital content in the database. The content control module is operable to generate capture data associated with the capture, which in some examples includes the recommendation score. Subsequently, the content control module can associate the instance of digital content with the capture data and upload the instance of digital content and/or the capture data to the database. In this way, the database is continuously updated with new instances of digital content and thus improves future recommendations for digital content captures.

Accordingly, using the techniques described herein, the client device is operable to provide recommendations for capturing digital content at particular locations with increased quality in an intuitive and efficient manner. These capabilities obviate the conventional limitation for a user to provide a “best guess” as to what will result in a desirable content capture or have advanced photography experience filmography or post-production skills to obtain quality digital content.

While features and concepts of digital content capture recommendations can be implemented in any number of environments and/or configurations, aspects of digital content capture recommendations are described in the context of the following example systems, devices, and methods.

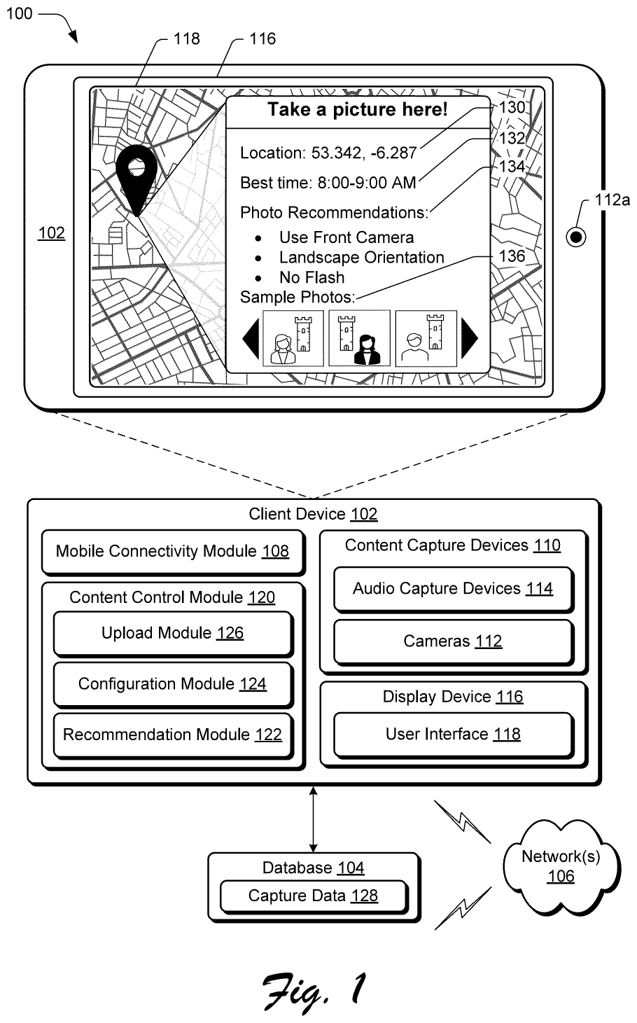

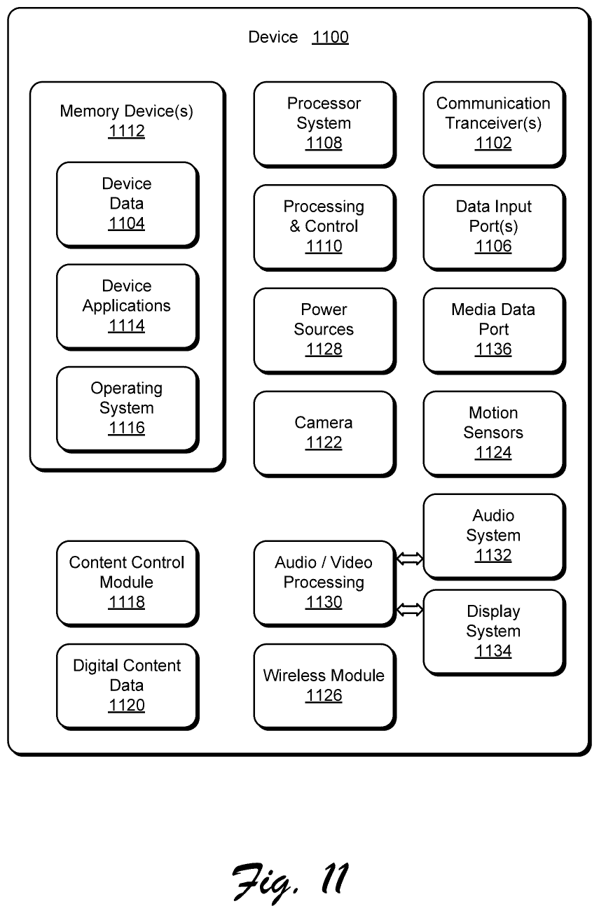

FIG. 1 illustrates an example environment 100 in which aspects of digital content capture recommendations can be implemented. The environment 100 includes a computing device such as a client device 102 and a database 104 that are interconnectable via network(s) 106. In this particular example, the client device 102 represents a multi-camera portable device that can be carried by a user, such as a smartphone or a tablet device. These examples are not to be construed as limiting, however, and the client device 102 can be implemented in a variety of different ways and form factors such as a digital camera, laptop computer, desktop computer, webcam, a docked mobile device connected to a monitor, and so forth. Example attributes of the client device 102 are discussed below with reference to the device 1100 of FIG. 11.

The client device 102 includes various functionality that enables the client device 102 to perform different aspects of digital content capture recommendations discussed herein, including a mobile connectivity module 108, content capture devices 110 including cameras 112 and audio capture devices 114, a display device 116 including a user interface 118, and a content control module 120. The mobile connectivity module 108 represents functionality (e.g., logic and hardware) for enabling the client device 102 to interconnect with other devices, storage systems, and/or networks, such as the network 106 and the database 104. The mobile connectivity module 108, for instance, enables wireless and/or wired connectivity of the client device 102.

The content capture devices 110 are representative of functionality to enable various types of media to be captured via the client device 102, such as visual media and audio media. In this particular example the content capture devices 110 include photo/video capture devices such as cameras 112 and audio capture devices 114. In one or more examples, the cameras 112 include a first camera, e.g., a front camera 112a used for capturing self-portrait content such as one or more “selfies,” and a second camera, e.g., a rear camera 112b. The content capture devices 110, however, can include a variety of other devices that are able to capture various types of media in accordance with the implementations discussed herein. The content capture devices 110, for instance, include not only hardware for capturing associated media but also logic (e.g., drivers, firmware, etc.) for operating and configuring operation of the associated content capture devices 110. The display device 116 represents functionality (e.g., hardware and logic) for enabling visual output via the client device 102. For instance, via a user interface 118.

The content control module 120 represents functionality for performing various aspects of digital content capture recommendations described herein and is illustrated as including a recommendation module 122, a configuration module 124, and an upload module 126. The content control module 120 is operable to receive an input including a request for recommendation for a digital content capture, for instance at a particular location. As described herein, the digital content capture is representative of a variety of content capture modalities, such as a photo capture, video capture, augmented reality/virtual reality (“AR/VR”) content capture, etc.

In various examples, the recommendation module 122 is employed to access the database 104 which includes capture data 128. While in the illustrated example the database 104 is depict as connected to the client device via network 106, in various examples the database 104 and client device 102 are connectable via wired and/or wireless connectivity to exchange information between the database 104 and the client device 102. In a wireless scenario, the client device 102 and the database are connected utilizing any suitable wireless protocol, such as Wi-Fi Direct, Bluetooth™ (including Bluetooth™ Low Energy (BLE), ultra-wideband (UWB), Near Field Communication (NFC)), LTE direct, NR sidelink, and so forth. In alternative or additional examples, the database 104 is implemented in hardware of the client device 102.

The capture data 128 can include a variety of digital content as well as a variety of information associated with the digital content such as metadata for the digital content. For an instance of digital content, the capture data 128 can include a geolocation, time of day, date, weather conditions, etc. associated with capture of the digital content. Further, the capture data 128 can include information associated with a device used to capture the instance of digital content such as whether a front or a rear camera captured the content, a device orientation, aperture size, shutter speed, ISO, brightness setting, flash setting, night mode, exposure setting, image filter, contrast setting, etc. In various examples, the capture data 128 includes demographic information associated with one or more users associated with capture devices that captured the digital content such as age, gender, nationality, etc.

Based on the capture data 128, the recommendation module 122 is operable to generate the recommendation, e.g., that instructs a user where, when, and how to capture one or more instances of digital content. For instance, the recommendation indicates a particular location, a time of day, a time of year, and/or suggested configuration settings to capture digital content. Once generated, the client device 102 is operable to output the recommendation for display, e.g., in the user interface 118. In various examples, the configuration module 124 is operable to configure the client device 102 with one or more configuration settings, e.g., automatically and without user intervention based on the recommendation.

In additional or alternative examples, the client device 102 captures an instance of digital content using one or more of the content capture devices 110. The upload module 126 is operable to generate capture data 128 particular to the instance of digital content, e.g., metadata associated with the instance of digital content. In one or more examples, the upload module 126 is employed to generate a recommendation score for the instance of digital content, e.g., that represents a value of the instance of digital content in generating a recommendation, as part of the capture data 128. Subsequently, the upload module 126 can communicate the instance of digital content and/or the capture data 128 to the database 104. In this way, the database 104 is continuously updated with new instances of digital content and thus improves future recommendations for digital content captures.

Example operations of digital content capture recommendations are illustrated in FIG. 1. In the example, the client device 102 is depicted as a multicamera mobile device with the front camera 112a disposed on the same side as the user interface 118 and the rear camera 112b disposed on the opposite side as the front camera 112a. The content control module 120 is operable to receive an input including a request for a recommendation for a digital content capture at a particular location. In the illustrated example, the particular location includes a historic monument such as a castle tower. The recommendation module 122 is operable to access the database 104 including capture data 128 associated with digital content captured at the castle tower.

Based on the capture data 128, the recommendation module 122 is operable to generate a recommendation for a digital content capture at the castle tower. In this example, the recommendation includes a suggested location 130 to take a photo, a suggested time of day 132 to capture the photo, as well as photo recommendations 134, e.g., suggested configuration settings for the client device 102. The photo recommendations 134 include a suggestion to use the front camera 112a, to use the client device 102 in a landscape (e.g., horizontal) orientation, and not to use a flash setting. The recommendation further includes sample photos 136, e.g., that provide visual examples of “good” captures. A sample photo 136 that provides an example of a good capture, for instance, represents a desirable content capture and can be based on social media statistics (e.g., a number of “likes” and/or “shares”) associated with the sample photos 136, AI-based content scoring algorithms, machine learning based image popularity assessments, recommendation scores associated with the sample photos 136, etc. Accordingly, the techniques described herein efficiently instruct a user of the client device 102 “when,” “where,” and “how” to obtain a desirable content capture.

Having discussed an example environment in which the disclosed techniques can be performed, consider now some example scenarios and implementation details for implementing the disclosed techniques.

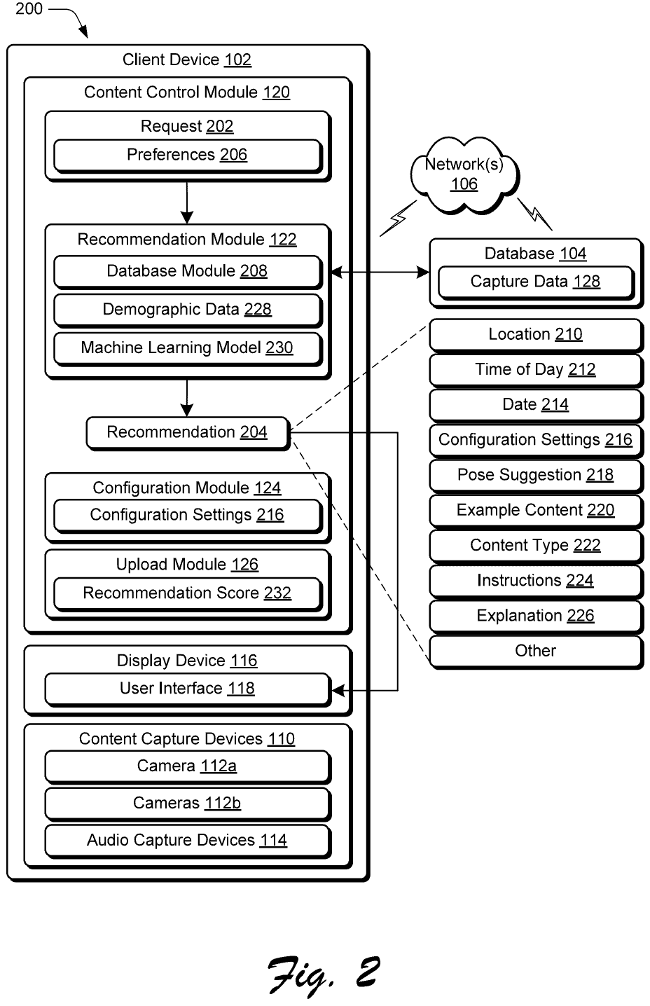

FIG. 2 depicts an example system 200 for digital content capture recommendations in accordance with one or more implementations. The system 200 can be implemented in the environment 100 and incorporates attributes of the environment 100 introduced above. In the example system 200, the content control module 120 receives an input including a recommendation request 202 for a recommendation 204 for a digital content capture, e.g., at or within a particular location. The particular location can be a geographical area (e.g., a country, state, city, etc.), a sight (e.g., a monument, attraction, viewpoint, vista, etc.), an address, GPS coordinates, etc. In an example, the particular location is associated with a search radius, e.g., a distance radius within which the recommendation 204 is to be generated.

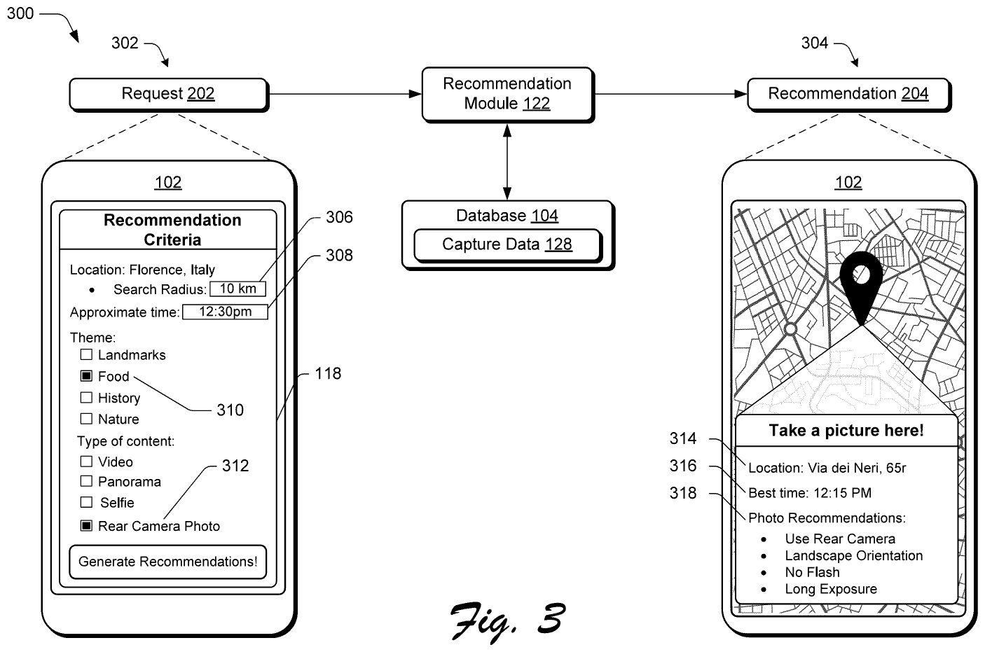

In an example, the request 202 is generated based on a user query, e.g., an input by a user in the user interface 118 to provide the recommendation 204. The request 202 can further include additional criteria such as one or more preferences 206, e.g., user specified preferences that can be used to generate the recommendation 204 as further described below. The preferences 206 can include one or more of a particular location, a time-of-day range, a date range, preferred capture types/styles, etc. In one example, the preferences 206 indicate that the user desires a recommendation 204 for a “popular” digital content capture, while in another example the specified preferences 206 indicate that the user desires a recommendation 204 for an “exclusive” digital content capture. In alternative or additional examples, the preferences 206 include one or more themes that can be used to generate the recommendation 204 in accordance with the one or more themes as further described below with respect to FIG. 3.

The request can also be generated automatically and without user intervention, e.g., responsive to a detection that the client device 102 is located at the particular location. For instance, the content control module 120 detects that the client device 102 is located near a historical monument, and automatically generates the recommendation 204 for a digital content capture including the historical monument. In an additional or alternative example, the request 202 is based on an itinerary as generated by and/or stored on the client device 102, e.g., where the itinerary identifies one or more destinations, and the particular location is one of the destinations.

Based on the request, the recommendation module 122 is operable to access the database 104, e.g., using a database module 208. The database module 208 is configured to initiate connectivity between the client device 102 and the database 104, e.g., via wired and/or wireless connectivity as described above. The database 104 includes capture data 128 associated with digital content captured at the particular location. The capture data 128 can include a variety of digital content (e.g., photos, and videos) as well as a variety of information associated with the digital content such as metadata for the digital content.

For instance, the capture data 128 can include a geolocation, time of day, date, weather conditions, etc. associated with capture of an instance of the digital content. Further, the capture data 128 can include device capture data, e.g., information associated with a device used to capture the instance of digital content such as whether a front or a rear camera captured the content, a three-dimensional device orientation, aperture size, shutter speed, ISO, brightness settings, flash setting, night mode, exposure setting, image filter, contrast settings, etc. In various examples, the capture data 128 includes demographic information associated with one or more users of capture devices that captured the digital content such as age, gender, nationality, etc. The capture data 128 can also include information about the digital content such as the type of digital content (e.g., a panoramic photo, “selfie” photo, live photo, video, etc.), a number of individuals depicted in the digital content, a recommendation score as further described below, social media statistics such as a number of likes and/or shares of the photo on social media, etc.

Based on the capture data 128, the recommendation module 122 is operable to generate the recommendation 204 for a digital content capture, e.g., instructing a user of the multicamera mobile device “where,” “when,” and “how” to capture a desirable instance of digital content. For instance, the recommendation 204 indicates one or more of a location 210 (e.g., a suggested geolocation), a time of day 212, a date 214, and/or configuration settings 216 for the client device 102 to capture digital content. In one or more examples, the configuration settings 216 include a front camera 112a or rear camera 112b suggestion, a suggested three-dimensional orientation of the client device 102, whether to capture digital content in a landscape or portrait mode, and/or whether/how to apply visual effects and camera features such as an aperture size, shutter speed, ISO, brightness setting, flash setting, night mode setting, exposure setting, image filter, contrast setting, etc. In an example, the recommendation 204 includes one or more suggested sites within the particular location, e.g., that specify a precise “spot” to stand to obtain the capture, as well as a direction to face to obtain the capture. In this way, the recommendation 204 can be configured to suggest multiple capture spots at a particular location, e.g., two or more suggested sites.

The recommendation module 122 can further configure the recommendation 204 to include one or more pose suggestions 218, example content 220 such as sample photos and/or videos, specification for content type 222, and/or instructions 224 to obtain the capture. In one or more examples, pose suggestions 218 can include an orientation of the user, facial expressions, posture, stance, bodily movements, etc. In various implementations, the recommendation 204 further includes an explanation 226 for the recommendation 204, e.g., indicating “why” the recommendation 204 will produce a desirable content capture. This is by way of example and not limitation, and the techniques described herein are extensible such that the recommendation 204 is configurable to include other relevant information for obtaining a desirable capture.

In one or more examples, the recommendation 204 is based on popularity of locations, times, dates, and various configuration settings included in the capture data 128. That is, the recommendation 204 can be based on a number of captures (e.g., number of photos taken) at the particular location, a number of captures at a particular time, a number of captures on a particular date, and/or a number of captures with particular device configuration settings. Thus, the number of captures indicates that the particular location/time/date/device settings are popular for capturing digital content.

In an example, the recommendation module 122 is operable to generate a heat map as part of generating the recommendation 204. For instance, the heat map represents popular sites for digital content captures within the particular location. In one or more examples, the heat map represents a temporal popularity of a particular site, e.g., how popular a site and/or particular location is at different times of the day and/or days of the week/month/year. A number of techniques are further considered to determine desirable content captures based on the capture data 128, such as social media statistics, e.g., a number of “likes” and/or “shares” for instances of digital content, AI-based image scoring algorithms, machine learning based image popularity assessments, recommendation scores associated with instances of digital content as further described below, etc.

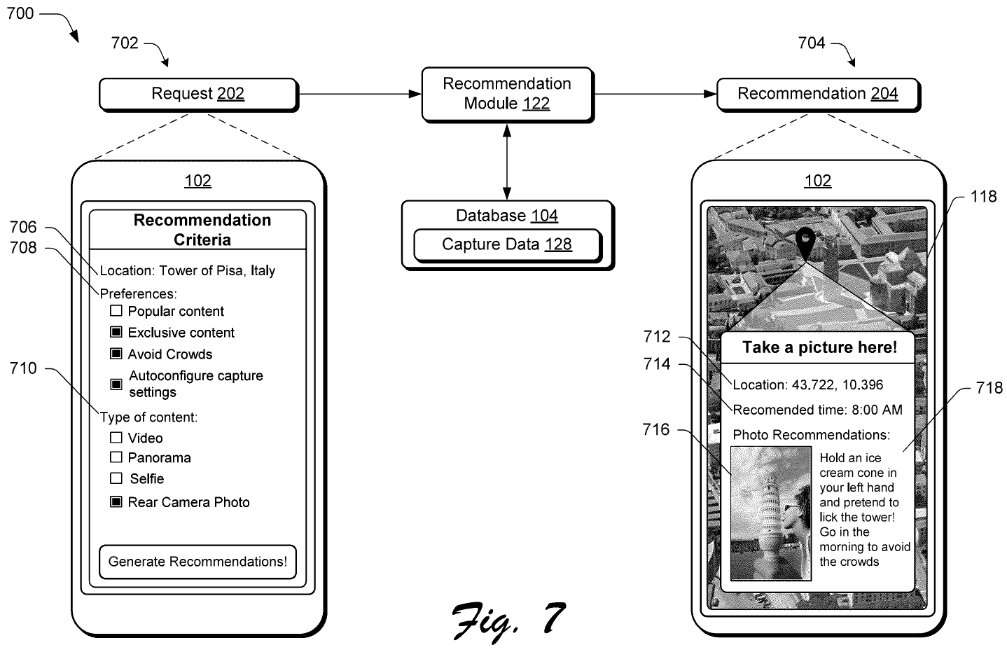

The recommendation module 122 is further operable to generate the recommendation 204 based in part on preferences 206, for instance as included as part of a user query as described above and/or as stored on the client device 102. Accordingly, the recommendation 204 can be generated for a user-specified location, a time-of-day range, a date range, for preferred capture types/styles, etc. In one example, the preferences 206 indicate that the user desires a recommendation for an exclusive content capture, and thus the recommendation module 122 is employed to generate a recommendation for a content capture location, time, and/or device settings that are desirable, however are sparsely represented or not represented by the capture data 128 as further described below with respect to FIG. 7.

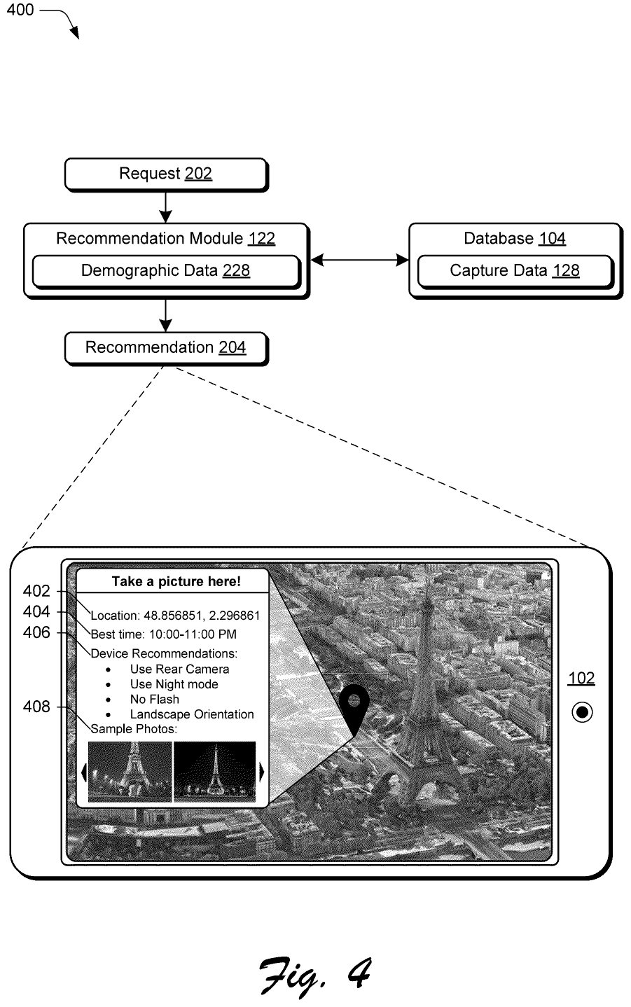

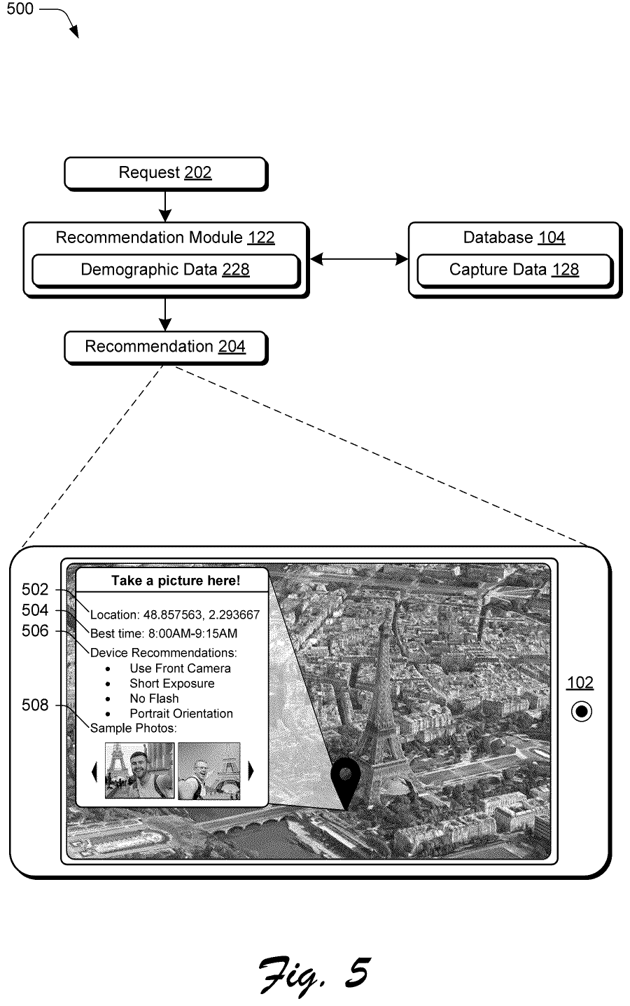

In one or more examples, the recommendation module 122 includes demographic data 228 associated with one or more users of the client device 102. The demographic data 228, for instance, includes age, gender, nationality, and other non-personally identifiable information data. The recommendation 204 can be based in part on the demographic data 228. For instance, the content control module is operable to filter the capture data 128 based on one or more relevant demographic characteristics included in the demographic data 228 as further described below with respect to FIG. 4 and FIG. 5. In various implementations, the content control module 120 is operable to remove personally identifiable information from the demographic data 228.

In some implementations the recommendation module 122 leverages a machine learning model 230 to generate the recommendation 204. For instance, the machine learning model 230 includes a machine learning collaborative filtering algorithm. The machine learning model 230 is configured to consider one or more of the capture data 128, preferences 206, and/or demographic data 228 to generate the recommendation 204. In an example, the machine learning model is trained using training data to generate a recommendation 204 for a desirable content capture. In this way, the content control module can generate recommendations 204 that are custom tailored for individual users in a variety of contexts.

Once generated, the content control module 120 is employed to output the recommendation 204 for display in the user interface 118 of the display device 116. As noted above, the recommendation 204 is configured to indicate one or more of a suggested location 210, time of day 212, date 214, and/or configuration settings 216 to optimize a content capture for a particular user. The recommendation 204 can also be configured to include pose suggestions 218, example content 220, specifications for content type 222, instructions 224 to obtain the capture and/or an explanation 226 for the recommendation 204. In this way, the content control module 120 can efficiently instruct a user of the client device 102 “when,” “where,” and “how” to obtain a desirable content capture as well as “why” a recommendation 204 is desirable, thus providing additional context for the user.

Further, the content control module 120 includes a configuration module 124 that is operable to automatically configure the client device 102 with the configuration settings 216, e.g., as included in the recommendation 204. For instance, the configuration module is operable to configure the client device 102 to activate the front camera 112a or rear camera 112b, generate an indication to orient the client device 102 to a particular three-dimensional orientation, initiate display on the display device 116 in either a landscape or a portrait mode, and/or implement visual effects such as aperture size, shutter speed, ISO, brightness settings, flash settings, night mode, exposure settings, image filters, contrast settings, etc. In an example, the configuration module 124 configures the client device 102 with the configuration settings 216 automatically and without user intervention responsive to a determination that the client device 102 is located at the particular location. Thus, the techniques described herein facilitate user efficiency to automatically configure the client device 102 with optimal settings for a digital content capture in various contexts.

Further, the content control module 120 is configured to initiate a capture of an instance of digital content, e.g., based on the recommendation 204 and using the content capture devices 110 such as cameras 112a, 112b and audio capture devices 114. An upload module 126 is operable to generate capture data 128 particular to the instance of digital content, e.g., metadata about the captured digital content as described above. In various implementations, the upload module 126 is operable to generate a recommendation score 232 for the instance of digital content. Generally, the recommendation score 232 represents a value of the instance of digital content to generate a recommendation 204. In some instances, the recommendation score 232 is a quantification, e.g., a numerical value. In alternative or additional examples, the recommendation score 232 is a qualification such as “high value,” “medium value,” “low value” etc.

The recommendation score 232 can be based on a variety of factors, such as a similarity to other instances of digital content captured at the particular location, social media statistics (e.g., a number of “likes” and/or “shares”), AI-based image scoring algorithms, machine learning based image popularity assessments, etc. In one or more examples, recommendation scores 232 associated with a plurality of instances of digital content stored in the database 104 are usable by the recommendation module 122 to generate the recommendation 204 for a desirable content capture. For instance, the recommendation module 122 leverages the recommendation scores 232 as a weighting to generate the recommendation 204.

In various examples, the upload module 126 is employed to associate the capture data 128, which in some instances includes the recommendation score 232, with the instance of digital content. The upload module 126 is further operable to communicate the capture data 128 and/or the instance of digital content to the database 104. In this way, the database is continuously updated with new instances of digital content and thus improves future recommendations for digital content captures.

FIG. 3 depicts an example implementation 300 for digital content capture recommendations in which the recommendation is based in part on user specified preferences in accordance with one or more implementations. In this example, shown in first stage 302 and second stage 304, the content control module 120 is operable to receive an input including a recommendation request 202 for a recommendation for a digital content capture at a particular location. As shown in first stage 302, the request 202 is a user query that specifies the particular location, e.g., the city of Florence, Italy. The user query further includes several preferences 206 as displayed in the user interface 118, for instance as specified by a user of the client device 102. For instance, the preferences 206 indicate a search radius 306 of 10 km, and thus recommendations 204 will be generated within a 10 km radius of the particular location. The preferences 206 further indicate an approximate time 308 of 12:30 PM, a “food” theme 310, and that the type of content 312 is to be a rear camera photo.

Accordingly, the recommendation module 122 is operable to generate a recommendation 204 based in part on these preferences in accordance with the techniques described above. As illustrated in second stage 304, the recommendation 204 is output in the user interface 118. The recommendation 204 includes a pin showing a location 314 for the recommended photo along with an address. In this example, the address associated with the location 314 is for a photogenic sandwich shop, e.g., based on a preference 206 for a food theme 310 as part of the recommendation 204. The recommendation 204 further includes a suggested time 316 to visit the location, and several device configuration recommendations 318. For instance, the device configuration recommendations include a suggestion to use the rear camera 112b, to orient the client device 102 in a landscape orientation, not to use flash, and to use a long exposure. Thus, the recommendation 204 is generated to consider the user specified preferences while concurrently optimizing quality for a digital content capture.

FIG. 4 depicts an example implementation 400 for digital content capture recommendations in which the recommendation is based in part on demographic data in accordance with one or more implementations. The content control module 120 is operable to receive an input including a recommendation request 202 for a recommendation for a digital content capture at a particular location. In this example, the particular location is the Eiffel Tower in Paris, France, and the request 202 is generated automatically responsive to a detection that the client device 102 is located in proximity to the Eiffel Tower. The recommendation module 122 includes demographic data 228 that indicates that the user of the client device 102 is a 40-year-old woman from the United States. Accordingly, the recommendation module 122 is operable to generate a recommendation for a desirable digital content capture based on the demographic data 228, e.g., for a 40-year-old woman from the United States.

The recommendation module 122 generates the recommendation by leveraging capture data 128 stored in the database 104 that includes similar demographic information to the demographic data 228. The recommendation 204 is further based on weather data indicating a time that the weather will be favorable for a content capture. In the illustrated example, a desirable content capture based on the user's demographics includes a night photograph of the Eiffel Tower from a location south of the tower. Accordingly, the recommendation 204 output in the user interface 118 includes a location 402 with precise GPS coordinates, a suggested time 404 to obtain the capture between 10:00 PM and 11:00 PM, and various device configuration settings 406. For instance, the device configuration settings 406 include suggestions to use the rear camera 112b, to use a “night mode” setting of the client device 102, to not use a flash, and to orient the client device 102 in a landscape configuration. The recommendation 204 further includes sample photos 408, thus providing a visual representation of what content captured based on the recommendation 204 may look like.

FIG. 5 depicts an example implementation 500 for digital content capture recommendations in which the recommendation is further based in part on demographic data in accordance with one or more implementations. Similar to the above example depicted in FIG. 4, in this example the content control module 120 is operable to receive an input including a recommendation request 202 for a recommendation for a digital content capture at the Eiffel Tower. However, in this example the recommendation module 122 includes demographic data 228 that indicates that the user of the client device 102 is a 30-year-old man from Sweden. Accordingly, the recommendation module 122 is operable to generate a recommendation for a desirable digital content capture based on the demographic data 228, e.g., for a 30-year-old man from Sweden.

The recommendation module 122 generates the recommendation by leveraging capture data 128 stored in the database 104 that includes similar demographic information to the demographic data 228. In the illustrated example, a desirable content capture based on the user's demographics includes a daytime self-portrait content (e.g., a “selfie”) located close to the tower on the east side. Accordingly, the recommendation 204 includes a location 502 with precise GPS coordinates, a suggested time 504 to obtain the capture in the morning, and various device configuration settings 506. For instance, the device configuration settings 506 include a suggestion to use the front camera 112a, e.g., to obtain a selfie. The device configuration settings 506 further include a suggestion to use a short exposure with no flash, and to position the client device 102 in a portrait orientation. The recommendation 204 further includes sample photos 508. Thus, a recommendation 204 for one user may differ than a recommendation 204 for another user. Using the techniques described herein, recommendations 204 can be custom tailored to individuals based on demographic information.

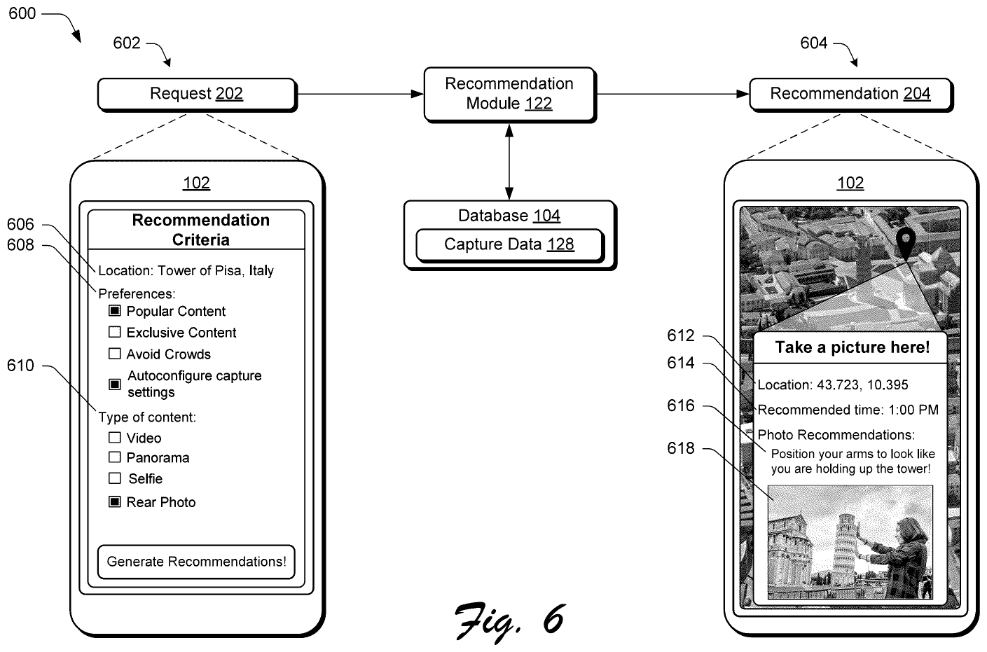

FIG. 6 depicts an example implementation 600 for digital content capture recommendations in which the recommendation includes a popular digital content capture suggestion in accordance with one or more implementations. In this example, shown in first stage 602 and second stage 604, the content control module 120 is operable to receive an input including a recommendation request 202 for a recommendation for a digital content capture at a particular location. As shown in first stage 602, the request 202 is a user query that specifies the particular location 606, in this example the Tower of Pisa, in Pisa, Italy. The user query further includes a specified preference 608 including a preference for a popular photo and a preference 610 for a rear photograph using the rear camera 112b.

Accordingly, in this example the recommendation 204 for a popular photo is based in part on a quantity of photos captured at sites around the Tower, a quantity of captures at a particular time, a quantity of captures on a particular date, and/or a quantity of photos captured using particular configuration settings. As depicted in second stage 604, the recommendation 204 includes a popular location 612, e.g., southwest of the Tower as shown with GPS coordinates, and a suggested popular time 614 of 1:00 PM. The recommendation 204 further includes a pose suggestion 616 for the subject to position their arms to give the visual impression that the subject is “bracing” the Tower from falling over, as well as a sample photo 618 providing a visual example of a good capture similar to the capture suggested by the recommendation 204.

FIG. 7 depicts an example implementation 700 for digital content capture recommendations in which the recommendation includes an exclusive content capture suggestion in accordance with one or more implementations. In this example, shown in first stage 702 and second stage 704, the content control module 120 is operable to receive an input including a recommendation request 202 for a recommendation for a digital content capture at a particular location. Similar to the above example depicted in FIG. 6, the request 202 is a user query that specifies the particular location 706 as the Tower of Pisa. The request 202 further includes user specified preferences 708 including a preference for an exclusive photo, a preference to avoid crowds, as well as a preference to autoconfigure the client device 102 with configuration settings 216, e.g., using the configuration module 124 as described above. The user query further includes a specified preference 710 for a type of content, e.g., for a photo using the rear camera 112b.

Accordingly, in this example the recommendation 204 is based on photographs included in the capture data 128 that are exclusive, e.g., that have few or no comparable instances of digital content represented by the capture data. The recommendation 204 is further based on one or more other metrics to determine desirable content captures, such as a recommendation score 232, social media statistics such as a number of “likes” and/or “shares” for instances of digital content, AI-based image scoring algorithms, machine learning based image popularity assessments, recommendation scores associated with instances of digital content, etc. Thus, the recommendation module 122 is operable to generate a recommendation 204 that represents a content capture that is not common as specified by the capture data 128, however is a desirable content capture.

As depicted in second stage 704, the recommendation 204 output in the user interface 118 includes a location 712, e.g., directly south of the Tower as shown with GPS coordinates and a dropped pin, and a suggested time 714 of 1:00 PM, e.g., before crowds are likely to be present based on the capture data 128. The recommendation 204 further includes a pose suggestion 716 along with instructions 718 for the subject to hold an ice cream cone in one hand and pretend to lick the Tower. Thus, the user of the client device 102 is presented with an exclusive suggestion for a content capture that is desirable as well as unique.

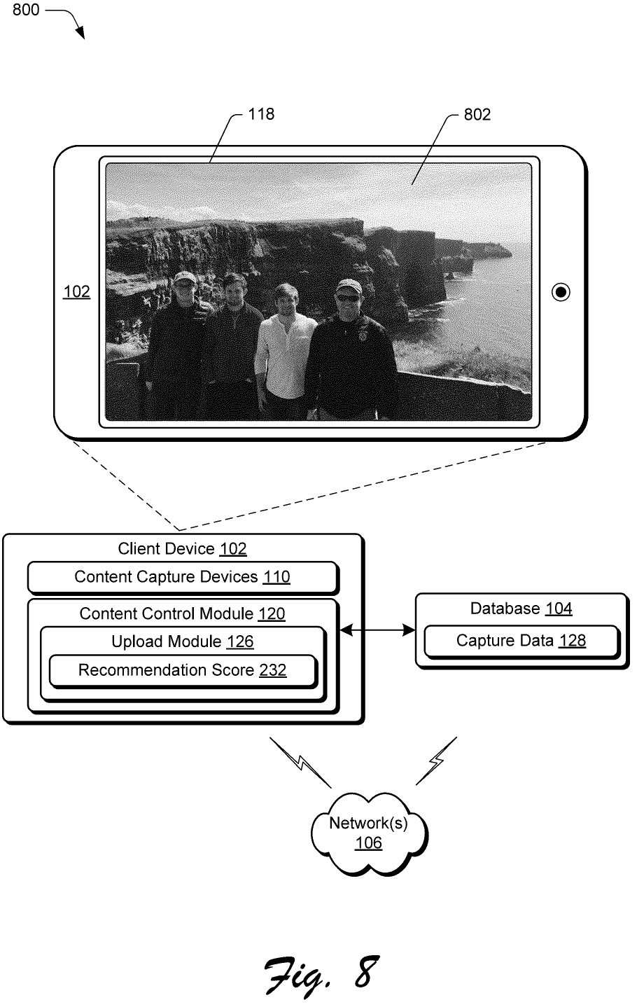

FIG. 8 illustrates an example implementation 800 for digital content capture recommendations in which a recommendation score is generated for an instance of digital content in accordance with one or more implementations. In this example, the content control module 120 is configured to initiate a capture of an instance of digital content 802, e.g., using the content capture devices 110 such as cameras 112a, 112b and audio capture devices 114. The upload module 126 is operable to generate capture data 128 particular to the instance of digital content. For instance, the upload module 126 determines a geolocation at the time of capture, a time of day, a date of the capture, weather conditions at the time of capture, etc. The capture data 128 further includes device capture data including that the rear camera 112b was used to obtain the capture, a landscape orientation for the device, an aperture size, a shutter speed, and an ISO setting.

Further, in this example the upload module 126 is operable to generate a recommendation score 232 for the instance of digital content 802 as part of the capture data 128. Generally, the recommendation score 232 represents a value of the instance of digital content to generate a recommendation 204. For instance, the recommendation score 232 indicates “how desirable” the instance of digital content 802 is, and thus “how influential” the instance of digital content 802 is for generating a recommendation 204. In this example, the recommendation score 232 is based on a similarity to other instances of digital content captured at the particular location. For instance, a high degree of similarity corresponds to a high recommendation score 232, while a low degree of similarity corresponds to a low recommendation score 232. The upload module 126 is then employed to communicate the capture data 128 including the recommendation score 232 to the database 104, for instance via the network 106. In this way, the database 104 is updated to include the instance of digital content 802 along with a score indicating its utility, which improves future recommendations 204 for digital content captures.

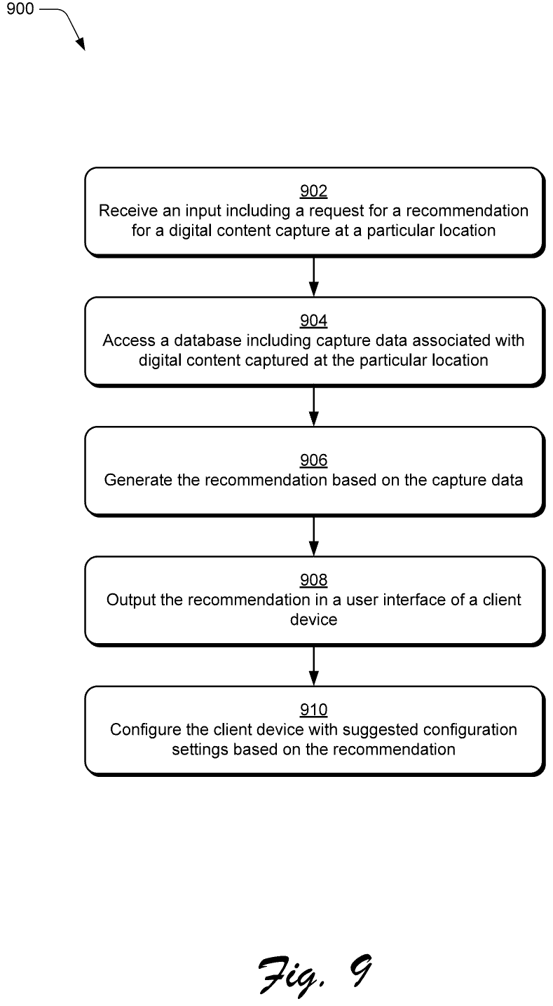

FIG. 9 illustrates a flow chart depicting an example method 900 for digital content capture recommendations in accordance with one or more implementations. At 902, an input including a request for a recommendation for a digital content capture at a particular location is received. In various implementations, the request is based on a user query, e.g., an input by a user in the user interface 118 to provide the recommendation 204. The request can further include additional criteria such as preferences 206, e.g., user specified preferences that can be used to generate the recommendation 204 as further described below. The preferences 206 can include one or more of a particular location, a time-of-day range, a date range, preferred capture types/styles, etc.

The request 202 can also be generated automatically and without user intervention, e.g., responsive to a detection that the client device 102 is located at the particular location. For instance, the content control module 120 detects that the client device 102 is located near a historical monument, and automatically generates the recommendation 204 for a digital content capture including the historical monument. In an additional or alternative example, the request 202 is based on an itinerary as generated by and/or stored on the client device 102, e.g., where the itinerary identifies one or more destinations, and the particular location is one of the destinations.

At 904, a database is accessed including capture data associated with digital content captured at the particular location. Generally, the capture data 128 includes a variety of information associated with the digital content. For instance, the capture data 128 includes a geolocation, time of day, date, weather conditions, etc. associated with capture of an instance of the digital content. Further, the capture data 128 can include device capture data, e.g., information associated with a device used to capture the instance of digital content. In various examples, the capture data 128 includes demographic information associated with one or more users of capture devices that captured the digital content. The capture data 128 can also include information about the digital content such as the type of digital content, a number of individuals depicted in the digital content, a recommendation score 232, etc.

At 906, the recommendation is generated based on the capture data. The recommendation 204 is generated based on a variety of factors, such as the capture data 128, one or more preferences 206, and/or user demographic data 228. In some implementations, a machine learning model 230 including a machine learning collaborative filtering algorithm is implemented by the content control module to consider one or more of the capture data 128, preferences 206, and/or demographic data 228 to generate the recommendation 204. In various examples, the recommendation 204 represents a desirable content capture, and indicates one or more of a location 210, a time of day 212, a date 214, and/or suggested configuration settings 216 for the client device 102 to capture digital content.

At 908, the recommendation is output in a user interface of a client device. The recommendation 204 is configured to indicate one or more of a suggested location 210, time of day 212, date 214, and/or configuration settings 216 to optimize a content capture for a particular user. The recommendation can also be configured to include pose suggestions 218, example content 220, specifications for content type 222, instructions 224 to obtain the capture and/or an explanation 226 for the recommendation 204. In this way, the content control module 120 can efficiently instruct a user of the client device 102 “when,” “where,” and “how” to obtain a desirable content capture as well as “why” a recommendation 204 is desirable, thus providing additional context for the user.

At 910, the client device is configured with suggested configuration settings based on the recommendation. In some examples, the client device 102 includes a configuration module 124 that is employed to apply one or more configuration settings 216 to the client device. For instance, based on the recommendation 204 the client device 102 is automatically configured to activate a front camera 112a or a rear camera 112b, generate an indication to orient the client device 102 to a particular three-dimensional orientation, initiate display on the display device 116 in either a landscape or a portrait mode, and/or implement visual effects such as configuring an aperture size, shutter speed, ISO, brightness settings, flash settings, night mode, exposure settings, image filters, contrast settings, etc. In an example, the configuration module 124 configures the client device 102 with the configuration settings 216 automatically and without user intervention responsive to a determination that the client device 102 is located at the particular location. Thus, the techniques described herein facilitate user efficiency by automatically configuring the client device 102 with optimal settings for a digital content capture in a particular context.

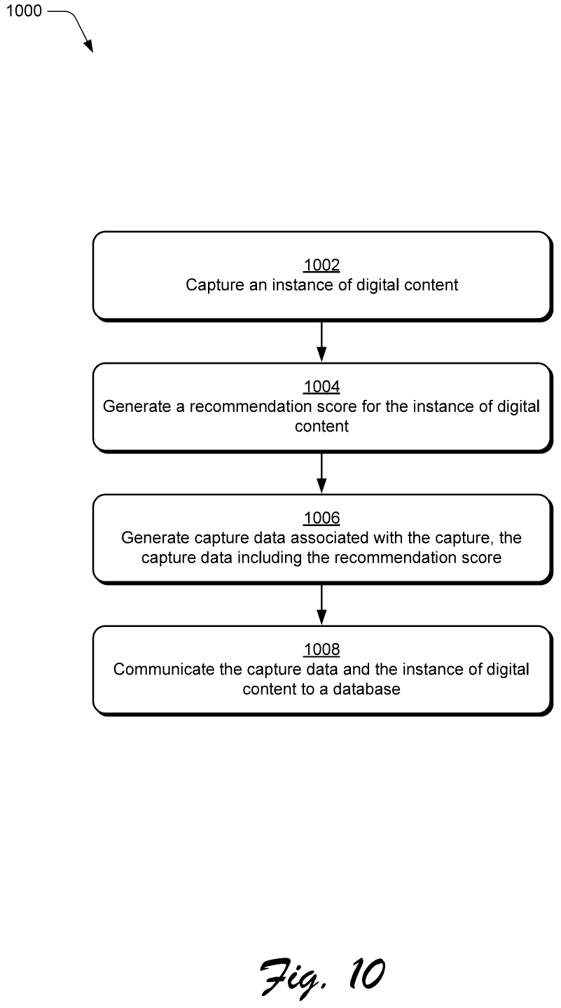

FIG. 10 illustrates a flow chart depicting an example method 1000 for digital content capture recommendations including generating a recommendation score in accordance with one or more implementations. At 1002, an instance of digital content is captured. In an example, the digital content is captured in accordance with the recommendation 204 using content capture devices 110 such as cameras 112a, 112b and audio capture devices 114. At 1004, a recommendation score is generated for the instance of digital content. Generally, the recommendation score 232 represents a value of the instance of digital content to generate a recommendation 204. The recommendation score 232 can be based on a variety of factors, such as a similarity to other instances of digital content captured at the particular location, social media statistics (e.g., a number of “likes” and/or “shares”), AI-based image scoring algorithms, machine learning based image popularity assessments, etc.

At 1006, capture data associated with the capture is generated. In some examples, the capture data 128 includes the recommendation score 232. For instance, an upload module 126 is operable to generate capture data 128 particular to the instance of digital content, e.g., metadata about the captured digital content as described above. At 1008, the capture data and the instance of digital content are communicated to a database. In an example, the upload module 126 is employed to communicate the capture data 128 and/or the instance of digital content to the database 104 via a network 106. In this way, the database is continuously updated with new instances of digital content and thus improves future recommendations for digital content captures.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 11 illustrates various components of an example device 1100 in which aspects of digital content capture recommendations can be implemented. The example device 1100 can be implemented as any of the devices described with reference to the previous FIGS. 1-10, such as any type of mobile device, mobile phone, mobile device, wearable device, tablet, computing, communication, entertainment, gaming, media playback, and/or other type of electronic device. For example, the client device 102 as shown and described with reference to FIGS. 1-10 may be implemented as the example device 1100.

The device 1100 includes communication transceivers 1102 that enable wired and/or wireless communication of device data 1104 with other devices. The device data 1104 can include any of device identifying data, device location data, wireless connectivity data, and wireless protocol data. Additionally, the device data 1104 can include any type of audio, video, and/or image data. Example communication transceivers 1102 include wireless personal area network (WPAN) radios compliant with various IEEE 1102.15 (Bluetooth™) standards, wireless local area network (WLAN) radios compliant with any of the various IEEE 1102.11 (Wi-Fi™) standards, wireless wide area network (WWAN) radios for cellular phone communication, wireless metropolitan area network (WMAN) radios compliant with various IEEE 1102.16 (WiMAX™) standards, and wired local area network (LAN) Ethernet transceivers for network data communication.

The device 1100 may also include one or more data input ports 1106 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 1100 includes a processing system 1108 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 1110. The device 1100 may further include any type of a system bus or other data and command transfer system that couples the various components within the device. A system bus can include any one or combination of different bus structures and architectures, as well as control and data lines.

The device 1100 also includes computer-readable storage memory 1112 (e.g., memory devices) that enable data storage, such as data storage devices that can be accessed by a computing device, and that provide persistent storage of data and executable instructions (e.g., software applications, programs, functions, and the like). Examples of the computer-readable storage memory 1112 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1100 may also include a mass storage media device.

The computer-readable storage memory 1112 provides data storage mechanisms to store the device data 1104, other types of information and/or data, and various device applications 1114 (e.g., software applications). For example, an operating system 1116 can be maintained as software instructions with a memory device and executed by the processing system 1108. The device applications may also include a device manager, such as any form of a control application, software application, signal-processing and control module, code that is native to a particular device, a hardware abstraction layer for a particular device, and so on. Computer-readable storage memory 1112 represents media and/or devices that enable persistent and/or non-transitory storage of information in contrast to mere signal transmission, carrier waves, or signals per se. Computer-readable storage memory 1112 do not include signals per se or transitory signals.

In this example, the device 1100 includes a content control module 1118 that implements aspects of digital content capture recommendations and may be implemented with hardware components and/or in software as one of the device applications 1114. In an example, the content control module 1118 can be implemented as the content control module 120 described in detail above. In implementations, the content control module 1118 may include independent processing, memory, and logic components as a computing and/or electronic device integrated with the device 1100. The device 1100 also includes digital content data 1120 for implementing aspects of digital content capture recommendations and may include data from and/or utilized by the content control module 1118.

In this example, the example device 1100 also includes a camera 1122 and motion sensors 1124, such as may be implemented in an inertial measurement unit (IMU). The motion sensors 1124 can be implemented with various sensors, such as a gyroscope, an accelerometer, and/or other types of motion sensors to sense motion of the device. The various motion sensors 1124 may also be implemented as components of an inertial measurement unit in the device.

The device 1100 also includes a wireless module 1126, which is representative of functionality to perform various wireless communication tasks. For instance, for the client device 102, the wireless module 1126 can be leveraged to scan for and detect wireless networks, as well as negotiate wireless connectivity to wireless networks for the client device 102. The device 1100 can also include one or more power sources 1128, such as when the device is implemented as a mobile device. The power sources 1128 may include a charging and/or power system, and can be implemented as a flexible strip battery, a rechargeable battery, a charged super-capacitor, and/or any other type of active or passive power source.

The device 1100 also includes an audio and/or video processing system 1130 that generates audio data for an audio system 1132 and/or generates display data for a display system 1134. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 1136. In implementations, the audio system and/or the display system are integrated components of the example device. Alternatively, the audio system and/or the display system are external, peripheral components to the example device.

Although implementations of digital content capture recommendations have been described in language specific to features and/or methods, the subject of the appended claims is not necessarily limited to the specific features or methods described. Rather, the features and methods are disclosed as example implementations of digital content capture recommendations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a computing device, including: a content capture device; and a content control module implemented at least partially in hardware and configured to: receive an input including a request for a recommendation for a digital content capture at a particular location; access a database including capture data associated with digital content captured at the particular location; generate the recommendation based on the capture data; and output the recommendation in a user interface of the computing device.

In some aspects, the techniques described herein relate to a computing device, wherein the capture data includes configuration settings from one or more devices used to capture the digital content including device orientation, whether a front or rear camera was used as part of a capture, an aperture size, a shutter speed, or an ISO setting.

In some aspects, the techniques described herein relate to a computing device, wherein the capture data includes one or more of a geolocation, a time of day, a date, or weather conditions associated with capture of the digital content.

In some aspects, the techniques described herein relate to a computing device, wherein the capture data includes demographic information associated with the digital content, and wherein generating the recommendation is based in part on demographic data associated with a user of the computing device.

In some aspects, the techniques described herein relate to a computing device, wherein the recommendation indicates a suggested geolocation, time of day, and configuration settings for the digital content capture.

In some aspects, the techniques described herein relate to a computing device, wherein the recommendation includes a suggested device orientation and a suggestion to use either a front camera of the computing device or a rear camera of the computing device.

In some aspects, the techniques described herein relate to a computing device, wherein the recommendation is based in part on one or more user specified preferences.

In some aspects, the techniques described herein relate to a computing device, wherein the request is generated automatically responsive to a determination that the computing device is located at the particular location.

In some aspects, the techniques described herein relate to a computing device, wherein the request is based on a user query that specifies the particular location.

In some aspects, the techniques described herein relate to a method, including: receiving an input including a request for a recommendation for a digital content capture within a particular location; accessing a database including capture data associated with digital content captured within the particular location; generating the recommendation based on the capture data, the recommendation including one or more suggested configuration settings for a client device; and configuring the client device with the one or more suggested configuration settings based on the recommendation.

In some aspects, the techniques described herein relate to a method, further including outputting the recommendation in a user interface of the client device, wherein the recommendation further includes one or more geolocations indicating one or more suggested sites within the particular location and a suggested time of day associated with the one or more suggested sites.

In some aspects, the techniques described herein relate to a method, wherein the one or more suggested configuration settings include one or more of a device orientation, a front or rear camera suggestion, a flash setting, a night mode setting, an exposure setting, a contrast setting, or a brightness setting.

In some aspects, the techniques described herein relate to a method, further including receiving one or more preferences specified by a user of the client device, and wherein the recommendation is further based on the one or more preferences.

In some aspects, the techniques described herein relate to a method, wherein the capture data includes demographic data associated with the digital content, and wherein the recommendation is based in part on demographic information associated with a user of the client device.

In some aspects, the techniques described herein relate to a method, wherein the client device is configured automatically responsive to a determination that the client device is located within the particular location.

In some aspects, the techniques described herein relate to a method, wherein the recommendation is based in part on a number of captures with particular device configuration settings included in the capture data.

In some aspects, the techniques described herein relate to a computing device, including: a content capture device; and a content control module implemented at least partially in hardware and configured to: initiate a capture of an instance of digital content using the content capture device; generate a recommendation score for the instance of digital content; generate capture data associated with the capture, the capture data including the recommendation score; and communicate the capture data and the instance of digital content to a database.

In some aspects, the techniques described herein relate to a computing device, wherein the recommendation score is based in part on a similarity of the instance of digital content to other digital content stored in the database.

In some aspects, the techniques described herein relate to a computing device, wherein the capture data includes one or more of a geolocation, a time of day, a date, or configuration settings associated with the capture of the instance of digital content.

In some aspects, the techniques described herein relate to a computing device, wherein recommendation score is based in part on one or more of social media statistics associated with the capture data, an AI-based content scoring algorithm, or a machine learning based image popularity assessment.

1. A computing device, comprising:
a content capture device; and
a content control module implemented at least partially in hardware and configured to:
receive an input including a request for a recommendation for a digital content capture at a particular location;
access a database including capture data associated with digital content captured at the particular location;
generate the recommendation based on the capture data; and
output the recommendation in a user interface of the computing device.

2. The computing device as described in claim 1, wherein the capture data includes configuration settings from one or more devices used to capture the digital content including device orientation, whether a front or rear camera was used as part of a capture, an aperture size, a shutter speed, or an ISO setting.

3. The computing device as described in claim 1, wherein the capture data includes one or more of a geolocation, a time of day, a date, or weather conditions associated with capture of the digital content.

4. The computing device as described in claim 1, wherein the capture data includes demographic information associated with the digital content, and wherein generating the recommendation is based in part on demographic data associated with a user of the computing device.

5. The computing device as described in claim 1, wherein the recommendation indicates a suggested geolocation, time of day, and configuration settings for the digital content capture.

6. The computing device as described in claim 1, wherein the recommendation includes a suggested device orientation and a suggestion to use either a front camera of the computing device or a rear camera of the computing device.

7. The computing device as described in claim 1, wherein the recommendation is based in part on one or more user specified preferences.

8. The computing device as described in claim 1, wherein the request is generated automatically responsive to a determination that the computing device is located at the particular location.

9. The computing device as described in claim 1, wherein the request is based on a user query that specifies the particular location.

10. A method, comprising:
receiving an input including a request for a recommendation for a digital content capture within a particular location;
accessing a database including capture data associated with digital content captured within the particular location;
generating the recommendation based on the capture data, the recommendation including one or more suggested configuration settings for a client device; and
configuring the client device with the one or more suggested configuration settings based on the recommendation.

11. The method as described in claim 10, further comprising outputting the recommendation in a user interface of the client device, wherein the recommendation further includes one or more geolocations indicating one or more suggested sites within the particular location and a suggested time of day associated with the one or more suggested sites.

12. The method as described in claim 10, wherein the one or more suggested configuration settings include one or more of a device orientation, a front or rear camera suggestion, a flash setting, a night mode setting, an exposure setting, a contrast setting, or a brightness setting.

13. The method as described in claim 10, further comprising receiving one or more preferences specified by a user of the client device, and wherein the recommendation is further based on the one or more preferences.

14. The method as described in claim 10, wherein the capture data includes demographic data associated with the digital content, and wherein the recommendation is based in part on demographic information associated with a user of the client device.

15. The method as described in claim 10, wherein the client device is configured automatically responsive to a determination that the client device is located within the particular location.

16. The method as described in claim 10, wherein the recommendation is based in part on a number of captures with particular device configuration settings included in the capture data.

17. A computing device, comprising:
a content capture device; and
a content control module implemented at least partially in hardware and configured to:
initiate a capture of an instance of digital content using the content capture device;
generate a recommendation score for the instance of digital content;
generate capture data associated with the capture, the capture data including the recommendation score; and
communicate the capture data and the instance of digital content to a database.

18. The computing device of claim 17, wherein the recommendation score is based in part on a similarity of the instance of digital content to other digital content stored in the database.

19. The computing device of claim 17, wherein the capture data includes one or more of a geolocation, a time of day, a date, or configuration settings associated with the capture of the instance of digital content.

20. The computing device of claim 17, wherein recommendation score is based in part on one or more of social media statistics associated with the capture data, an AI-based content scoring algorithm, or a machine learning based image popularity assessment.
